(19) United States
(12) Patent Application Publication
(10) Pub. No.: US 2003/0229556 A1
(43) Pub. Date: Dec. 11, 2003

(54) Methods and systems for providing a financial early warning of default

(76) Inventors: Radu Neagu, Schenectady, NY (US); Kannan Ramanathan, Niskayuna, NY (US); Roger Hoerl, Niskayuna, NY (US); Jason Weisman, Stamford, CT (US); Chandrasekhar Pisupati, Schenectady, NY (US); Sung-Ho J. Ahn, Clifton Park, NY (US); Michael Shaw, Roslyn Heights, NY (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/162,217

(22) Filed: Jun. 5, 2002

(51) Int. Cl. G06F 17/60

(52) U.S. Cl. 705/36

(57) ABSTRACT

The invention provides for processing of data to determine the likelihood of default of an entity. The processing may comprise obtaining a data set relating to an entity, the data set including at least a first likelihood of default indicator (LDI) value and a second LDI value; determining a LDI rate of change, based on the first LDI value and the second LDI value, to provide a LDI slope value; and determining the likelihood of default of the entity based on the LDI slope value and the first LDI value.

### BACKGROUND OF THE INVENTION

The systems and methods of the invention are directed to providing an early warning system regarding the likelihood of an entity to go into default.

The detection of the slide towards default by a firm, company or other entity at an early enough stage, in order to derive economic benefits, has long been the interest of practitioners in the financial sector. Signals of a company's deteriorating condition are typically produced sequentially starting many years before the actual default. The characteristics exhibited by a company experiencing financial problems differ from those of healthy companies. As the company's financial and economic condition deteriorates, the characteristics of the company shift towards those of defaulted companies. Completion of this shift usually takes years raising the requirement and opportunity of signaling this shift early in time so that business decisions can be made to the advantage of the practitioner.

Researchers in finance and accounting have developed several models for solving the problem of early default detection. Also, statistical techniques such as discriminate analysis, linear probability, logit, and probit models, have been widely used to develop business default prediction models. However, these models have various shortcomings. The main flaws of these models are that they are static in nature. That is, the model parameters need updating each time new data is available. Further, the models ignore useful information from the past financial condition of the firm.

Illustratively, the Expected Default Frequency (EDF) metric produced by Moody's KMV Development provides a useful metric for predicting company default. However, the EDF metric, from a practical standpoint, lacks usable information in the region of low to medium EDF's. Further, the EDF metric does not use available information to the extent possible.

The systems and methods of the invention address the problems set forth above, as well as other shortcomings in known processes and systems.

### BRIEF SUMMARY OF THE INVENTION

The invention provides for processing of data to determine the likelihood of default of an entity. The processing may comprise obtaining a data set relating to an entity, the data set including at least a first likelihood of default indicator (LDI) value and a second LDI value; determining a LDI rate of change, based on the first LDI value and the second LDI value, to provide a LDI slope value; and determining the likelihood of default of the entity based on the LDI slope value and the first LDI value.

In accordance with a further embodiment, the invention provides a computer readable memory for directing the operation of a processing system to determine the likelihood of default of an entity, the computer readable memory comprising: a first portion that stores a data set relating to an entity, the data set including at least a first likelihood of default indicator (LDI) value and a second LDI value; a second portion to determine a LDI rate of change, based on the first LDI value and the second LDI value, to provide a LDI slope value; and a third portion to determine the likelihood of default of the entity based on the LDI slope value and the first LDI value, the first LDI value being a present value.

In accordance with a further embodiment, the invention provides a system for determining the likelihood of default of an entity, the system comprising: a memory portion that stores a data set relating to an entity, the data set including at least a first likelihood of default indicator (LDI) value and a second LDI value; a slope determination portion that determines a LDI rate of change, based on the first LDI value and the second LDI value, to provide a LDI slope value; and an assessment portion to determine the likelihood of default of the entity based on the LDI slope value and the first LDI value.

In accordance with a further embodiment, the invention provides a method for processing data to determine the likelihood of default of an entity, the method comprising: obtaining a data set relating to an entity, the data set including at least a first likelihood of default indicator (LDI) value and a second LDI value; inputting an LDI slope value, the LDI slope value having been determined from a LDI rate of change based on the first LDI value and the second LDI value; and determining the likelihood of default of the entity based on the LDI slope value and the first LDI value.

In accordance with a further embodiment, the invention provides a method for processing data to determine the likelihood of default of an entity, the method comprising: obtaining a data set relating to an entity, the data set including at least a first likelihood of default indicator (LDI) value and a second LDI value, the first LDI value is a present day value and the second LDI value is a past day value; determining a LDI rate of change, based on the first LDI value and the second LDI value, to provide a LDI slope value; and determining the likelihood of default of the entity based on the LDI slope value and the first LDI value; and wherein the data set further includes a past window of LDI values and a present window of LDI values; the past window of LDI values containing a plurality of past LDI values disposed in time proximity to the second LDI value; and the present window of LDI values containing a plurality of present LDI values disposed in time proximity to the first LDI value; and wherein the determining the LDI rate of change is performed based on the past window of past LDI values and the present window of present LDI values, the determining the LDI rate of change based on the past window of LDI values and the present window of LDI values includes smoothing the second LDI value and smoothing the first LDI value to respectively generate a past smoothed value and a present smoothed value; and wherein the past smoothed value is compared with the present smoothed value to provide the LDI slope value.

In accordance with a further embodiment, the invention provides a computer readable memory for directing the operation of a processing system to determine the likelihood of default of an entity, the computer readable memory comprising: a first portion that stores a data set relating to an entity, the data set including at least a first likelihood of default indicator (LDI) value and a second LDI value, the first LDI value being a present day value and the second LDI value being a past day value; a second portion to determine a LDI rate of change, based on the first LDI value and the second LDI value, to provide a LDI slope value; and a third portion to determine the likelihood of default of the entity based on the LDI slope value and the first LDI value, the first LDI value being a present value; and wherein the data set further includes a past window of LDI values and a present window of LDI values; the past window of LDI values containing a plurality of past LDI values disposed in time proximity to the second LDI value; and the present window of LDI values containing a plurality of present LDI values disposed in time proximity to the first LDI value, the second portion determining the LDI rate of change based on the past window of past LDI values and the present window of present LDI values by smoothing the second LDI value and smoothing the first LDI value; and smoothing the second LDI value results in the generation of a past smoothed value; and smoothing the first LDI value results in the generation of a present smoothed value; and wherein the second portion compares the past smoothed value with the present smoothed value to provide the LDI slope value.

In accordance with a further embodiment, the invention provides a system for determining the likelihood of default of an entity, the system comprising: a memory portion that stores a data set relating to an entity, the data set including at least a first likelihood of default indicator (LDI) value and a second LDI value, the first LDI value is a present day value and the second LDI value is a past day value; a slope determination portion that determines a LDI rate of change, based on the first LDI value and the second LDI value, to provide a LDI slope value; and an assessment portion to determine the likelihood of default of the entity based on the LDI slope value and the first LDI value; and wherein the data set further includes a past window of LDI values and a present window of LDI values; the past window of LDI values containing a plurality of past LDI values disposed in time proximity to the second LDI value; and the present window of LDI values containing a plurality of present LDI values disposed in time proximity to the first LDI value; and wherein the slope determination portion determines the LDI rate of change based on the past window of past LDI values and the present window of present LDI values, the slope determination portion determining the LDI rate of change based on the past window of LDI values and the present window of LDI values includes smoothing the second LDI value and smoothing the first LDI value; and wherein: smoothing the second LDI value results in the generation of a past smoothed value; and smoothing the first LDI value results in the generation of a present smoothed value; and wherein the slope determination portion compares the past smoothed value with the present smoothed value to provide the LDI slope value, the comparing the past smoothed value with the present smoothed value to determine the LDI rate of change includes using a relationship:

LDI rate of change=100×(present smoothed value−past smoothed value)/past smoothed value.

### BRIEF DESCRIPTION OF THE DRAWINGS

The present invention can be more fully understood by reading the following detailed description together with the accompanying drawing, in which like reference indicators are used to designate like elements, and in which:

FIG. 1 is a diagram showing a risk space in accordance with one embodiment of the invention;

FIG. 2 is a diagram showing further details of the risk space in accordance with one embodiment of the invention;

FIG. 3 is a block diagram showing a monitoring system in accordance with one embodiment of the invention;

FIG. 4 is a block diagram showing further details of the monitoring entity of FIG. 3 in accordance with one embodiment of the invention;

FIG. 5 is a high level flowchart showing a financial determination process in accordance with one embodiment of the invention;

FIG. 6 is a flowchart showing in further detail the “determine operating parameters” step of FIG. 5 in accordance with one embodiment of the invention;

FIG. 7 is a flowchart showing in further detail the “monitor target entity” step of FIG. 5 in accordance with one embodiment of the invention; and

FIG. 8 is a diagram showing aspects of a smoothing process in accordance with one embodiment of the invention.

### DETAILED DESCRIPTION OF THE INVENTION

Hereinafter, aspects of various embodiments of the invention will be described. As used herein, any term in the singular may be interpreted to be in the plural, and alternatively, any term in the plural may be interpreted to be in the singular.

The invention is directed to the above stated problems described in the “Background of the Invention,” as well as other problems, that are present in conventional techniques. The foregoing description of various methods and/or systems and their attendant disadvantages described in the in the “Background of the Invention” is in no way intended to limit the scope of the invention, or to imply that the invention does not include some or all of various elements of known methods and/or systems in one form or another. Indeed, various embodiments of the invention may be capable of overcoming some of the disadvantages noted in the “Background of the Invention,” while still retaining some or all of various elements of known methods and/or systems in one form or another.

The systems and methods of the invention provide a technique to determine that an entity, such as a company or a firm, for example, is likely to go into default. In particular, the invention provides a system of rules that gives signals to indicate that a company is likely to go into default.

One objective of the rules used in the invention is to identify a high percentage of the companies that actually end up defaulting. This identification should be done while providing enough head time to allow for profitable business decisions on the signaled companies. However, at the same time, the rules used in the invention should perform well in distinguishing between companies that will actually default versus companies that will not go into a default, i.e., over a certain future time frame.

In accordance with one aspect of the invention, the rules used in the invention may be assessed based on the occurrence of two types of errors. One type of error involves the situation when a company is not signaled and that company does indeed default. This type of error may be characterized as a Type I error, i.e., “missed defaults.” In contrast, Type II errors, i.e., false signals, relate to the situation when a company is signaled to default, but in fact does not default. The quality of the rule system used in accordance with one embodiment of the invention involves looking at the balance between the two errors.

Hereinafter, further aspects of the systems and methods of the invention will be described in further detail. It should be appreciated that for an investment manager, receiving an early warning signal on companies in her/his portfolio that are most likely to experience financial problems leading to default in the near future, is very important. The invention provides an investment manager, or any other person, with the ability of producing these early warning signals.

In accordance with one embodiment of the invention, the starting point for the analysis is a metric introduced by the entity Moody's KMV Development, i.e., the “Expected Default Frequency” (EDF). An EDF value represents, for a particular company of interest and for a particular month in time, the probability that the company will go into default in the coming year, i.e., relative to the month on which the EDF value is computed. Therefore, the EDF value is constructed to be a predictor of default. The systems and methods of the invention use multiple EDF values and process these EDF value so as to provide a better predictor of a company's likelihood to default.

That is, the systems and methods of the invention process EDF values to generate what might be characterized as an “EDFSlope” or more generally, a slope of the change in “probability of default” metric. Such a slope metric may then be used together with the EDF metric to further enhance the default predictability power. The slope value quantifies the magnitude of the change in the EDF over a certain period of time and is indicative of worsening financial status. Further, the slope metric of various embodiments of the invention brings additional predictive power over the conventional EDF metric.

However, the systems and methods in accordance with the various embodiments of the invention are not limited to using the EDF metric generated by KMV. Other metrics that predict the likelihood of an entity's financial default might also be used in lieu of the EDF values. These other metrics might each be generally described as a “likelihood of default indicator (LDI)” metric. Accordingly, a “likelihood of default indicator (LDI)” value and/or metric as used herein includes the known EDF metric, as well as other metrics that might be used in lieu of the EDF metric.

As described in detail below, in some embodiments, the systems and methods of the invention process EDF values to generate an EDF slope. That is, as used herein, the systems and methods of the invention more generally process “LDI” values to generate an LDI slope. Accordingly, EDF values might be used to generate the LDI slope, or alternatively, some other likelihood of default indicator (LDI) values might be used to generate the LDI slope.

In accordance with one embodiment of the invention, a set of early warning signals is introduced based on the LDI metric, as well as the LDI slope metric. These two metrics are dependent on each other. Accordingly, it should be appreciated that the weight associated with each metric varies depending on the range of the LDI. That is, for large LDI values, the LDI slope metric may bring little contribution towards predicting defaults. Further, it should also be appreciated that for small LDI values the LDI slope metric used in the invention may bring little contribution towards predicting defaults. However, the systems and methods of the invention are particularly useful in the middle range of LDI values. It is in this range that the prediction of companies that eventually go into default is most challenging.

The method in accordance with one aspect of the invention begins with a company of interest. Illustratively, a “monitoring entity” might be watching the company and interested in the financial well being of the company, for any of a wide variety of reasons. For example, the company might be part of the monitoring entity's investment portfolio. The monitoring entity company, in this example, possesses history data including monthly, for example, LDI values for the past 5 years, for example. However, the LDI value might be hourly, daily, weekly or any other period of time.

U.S. Pat. No. 6,078,903, which is incorporated herein by reference in its entirety, describes various aspects of LDI values, i.e., more specifically Expected Default Frequency (EDF) values. LDI values, in accordance with one embodiment of the invention, may be between 0.0002 and 0.2 (0.02% and 20%), with values below 0.0002 (0.02%) considered insignificant. On the other hand, LDI values of 0.2 and above 0.2 (20%) are considered to carry equal weight towards prediction of default. Thus, in accordance with one aspect of the invention, if the LDI value is considered as the only measure for predicting default, then the “risk space” is 1-dimensional.

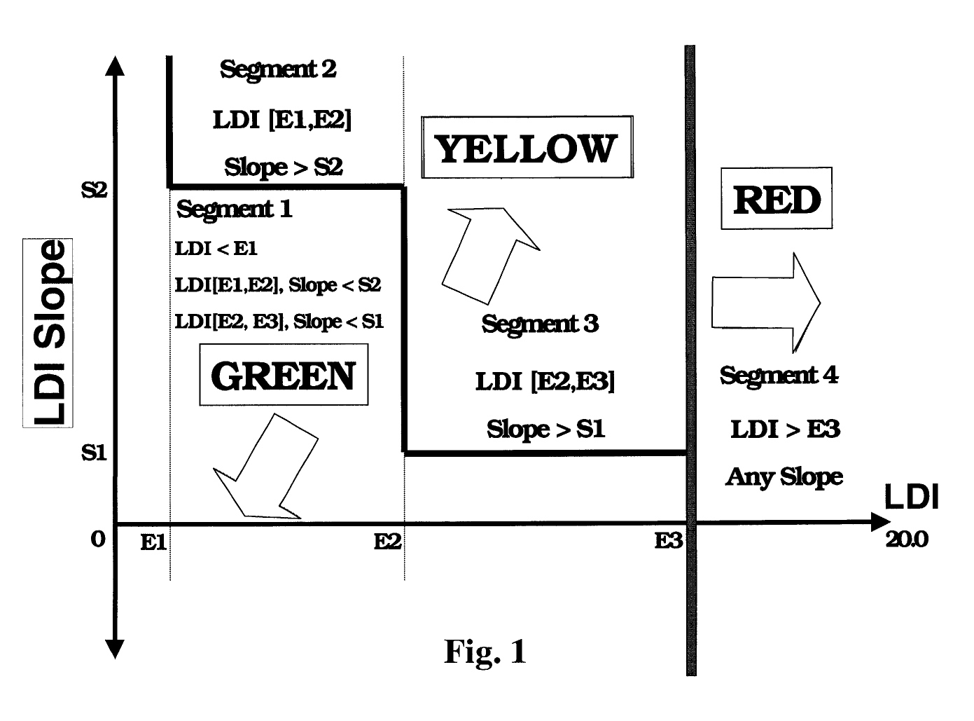

As shown in FIG. 1, the method of the invention provides an additional dimension. That is, an extra dimension to the risk space is added by considering LDI Slope. Accordingly, the risk space becomes 2-dimensional. As shown in FIG. 1, the LDI values are placed on the horizontal axis. Further, the LDI Slope values are placed on the vertical axis. Further aspects of FIG. 1 are described below.

In order to calculate the LDI slope value, it may be desirable to smooth the data upon which the LDI slope is based. This smoothing may be performed using a moving average (MA) filter, for example. The smoothing process may be used to generate a time series of smoothed LDI values. Further, the LDI slope may then be determined based on the smoothed LDI values. In accordance with one embodiment of the invention, the LDI Slope is determined using the formula:

LDISlope_{—}t=100×(LDIt−LDIt−k)/LDIt−k Equation 1

Wherein:

LDISlope_t is the slope;

“LDIT” is the smoothed LDI value at a time “t”;

“LDIt−k” is the smoothed LDI value at a time “t−k”; and

wherein “t” is a particular time; “k” is a time lag; and “t−k” is a particular time previous to the time “t” by the amount of time lag “k”.

At any point in time, a particular company plots as a point in the risk space defined by the LDI and LDISlope values. As shown in FIG. 1, the risk space is partitioned into three zones.

These zones include a Red Zone (action zone), a Yellow Zone (watch list zone), and a Green Zone (no action zone). For companies whose (LDIt, LDISlope_t) at time t falls in the Red Zone, the method, in accordance with one embodiment of the invention, recommends that action should be taken. For companies that fall in the Yellow Zone, the method, in accordance with one embodiment of the invention, recommends adding such companies to a watch list for close supervision. Further, companies falling in the Green Zone require no action at that point in time.

The reasoning behind the partition into zones is based on various observations. These observations include that large LDI values indicate poor financial situation, i.e., high probability of default. Also, large LDISlope values indicate deteriorating financial situation, i.e., a worsening outlook.

As a result, a situation that should produce a signal, so that a potentially defaulting company is identified, includes a case with a low LDI level and with a large LDISlope. Additionally, cases that should produce a signal are those cases with a large LDI level, and with either small or large LDISlope. Based on this understanding, the possible “risk space,” which is formed by the LDI values and the LDISlope, can be divided into the zones as shown in FIG. 1 and described herein, including a green zone, a yellow zone and a red zone.

It should of course be appreciated that the particular values used to define the zones may be changed based on various factors including particulars of the target company, the particular investment situation, or any other factors. In developing the thresholds shown in FIG. 1, the thresholds E1, E2, E3, S1, and S2 may be derived through simulation, as well as optimizing the proportion of defaults not identified vis-á-vis the proportion of false alarms. Further aspects of the thresholds E1, E2, E3, S1, and S2 are described below.

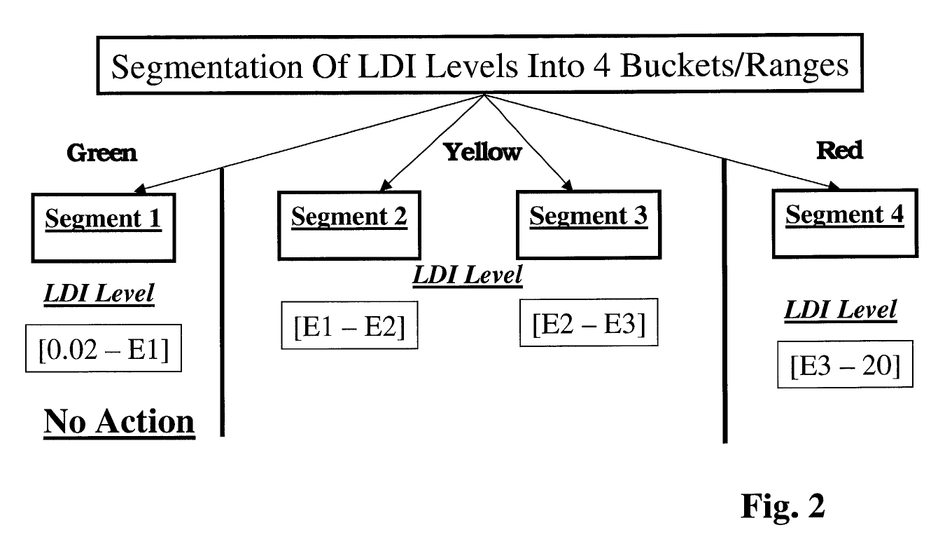

FIG. 2 is a diagram showing further aspects of the invention. FIG. 2 shows the manner in which the LDI values may be broken into segments or ranges. Specifically, segment 1 is defined by an LDI level from 0.02 to E1. If a company's LDI is below E1, then the company is deemed to be in good financial shape. As a result, the likelihood of the company going into default in the near future is very small. Accordingly, there is no action required for that particular company.

The diagram of FIG. 2 also includes segment 4. Segment 4 is defined by an LDI level of E3-20. In accordance with one aspect of the invention, companies having LDIs that cross the E3 threshold, i.e., LDI>E3, are likely to default. For example, using a value of (E3=7), it has been observed in illustrative results, from the time when the crossing happens, 19% default within a year. Further, it has been observed that from the time of crossing the E3 threshold, 38% default within two years and 54% of companies default within three years. As a result, LDI Slope may not be significant in this large LDI range, i.e., segment 4. Further, it should be appreciated that an (LDI>E3) provides, in and of itself, a stand-alone signal that requires action from the practitioner.

Accordingly, the LDISlope may not be significant in either segment 1 or segment 4, as shown in FIG. 2. However, in the middle LDI range [E1-E3] in particular, LDI Slope brings additional information to enable enhanced default prediction. Accordingly, the range [E1-E3] is the LDI range where the systems and methods of the invention may be most helpful.

In accordance with one embodiment of the invention, by using the LDISlope in the middle range [E1-E3], an early warning signal is provided before the LDI crosses the E3 threshold. This is helpful in that the numbers associated with the E3 threshold show very strong indication of near future financial distress. As a result, the time frame left for the practitioner to make profitable business decisions, i.e., after the company crosses the E3 threshold, may otherwise be too short. Therefore, by adding the information provided by the LDI Slope, in the specified LDI range, the method of the invention alerts a practitioner early enough such that the practitioner has enough time to make profitable business decisions.

For a company that is under analysis, the practitioner would first obtain the most recent LDI data. Then, the calculation of the LDISlope follows. The pair of values, i.e., the LDIcurrent and the LDISlope current, allows a company to be plotted in the risk space, as shown in FIG. 1.

The systems and methods of the invention provide various advantages by enhancing default prediction through the use of the LDI Slope. This gives enough lead time to practitioners so that they can make profitable business decisions. The systems and methods of the invention further provide an arrangement that generates alerts and associates actions with each such alert. In addition, the method of the invention is simple, fast and easy to use.

It should be appreciated that various considerations may be taken into account in determining the various segments and providing the definition of a Red Zone, a Yellow Zone and a Green Zone. In accordance with one embodiment of the invention, this determination may first include the determination of the Red Zone. Thereafter, the generation of the zones may include—the partition of the non-Red Zone into a Green Zone and Yellow Zone.

In further explanation, the Red Zone is the zone in which immediate action is required. Therefore, the definition of the red zone must be the result of analytics that suggest, with high confidence, that the future outlook of a company is towards worsening of credit. In accordance with one aspect of the invention, the inventors of the invention used a test dataset of 1986 North American public companies. In the dataset, there were 242 defaults over the time period April 1997 and April 2002. Further, an exploratory data analysis may be performed to determine a particular suitable methodology of computing the slope. That is, it is contemplated that the slope of the change in the LDI might be computed in a different manner than Equation 1 above. Determining a different manner may include a visual exercise, so as to explore different statistical approaches to determining the slope. Further, the particular smoother used may vary dispending on the current situation. Further, the value of “k”, i.e., the time lag, may also vary, for example.

An “optimum” set of rules, i.e., a methodology of computing the slope and setting the thresholds, may be characterized in terms of the balance between the Type I and Type II errors. A Type I error is defined as the percentage, out of all defaulting companies, of total instances when a rule system did not give a signal at least 6 months prior to the actual default. On the other hand, a Type II error is defined over a future time period delta(t) as the percentage, out of all signals given, of instances for which a signal was produced, but no default occurred over the delta(t) time interval, after the date of the signal. It should be appreciated that a person or entity might well be more concerned with a Type I error, i.e., where a company defaulted and no trigger was provided, than with a type II error. The potential loss associated with a Type I error may be very large. Accordingly, it may typically take many, many Type II errors to balance with one Type I error.

Accordingly, an optimization exercise was run and led to a determination of the rule (LDI>E3), for example, as desirable from a Type I/Type II error balance prospective. The performance of this rule may illustratively lead to identify 82% of defaulted companies at least 6 months prior to default date. Other typical results might be to have 19% of (LDI>E3) triggered companies default within one year of alert date; have 38% of (LDI>E3) triggered companies default within two years, and have 54% of (LDI>E3) triggered companies default within three years. Accordingly, in accordance with one embodiment of the invention, a company is defined as being in the Red Zone whenever the company satisfies the above rule, i.e., when its LDI>E3.

Once the Red Zone is defined, as illustratively described above, the next step, in accordance with one embodiment of the invention, is the partition of the Non-Red Zone into a Green Zone and a Yellow Zone. This partition may be performed by running the constrained optimization problem on different alert systems selected through an exploratory data analysis exercise.

That is, the LDI range of [0.02-E3] is segmented vertically into three “buckets.” These buckets include:

[0.02-E1];

[E1-E2]; and

[E2-E3].

The lower LDI “bucket”′ [0.02-E1] is defined as the Green Zone. Further, the LDI Slope is used to further split the [E1-E2] and [E2-E3] “buckets” horizontally. This is performed in such a manner that the upper part defines the Yellow Zone, that is:

(E1<LDI≦E2 and LDISlope≧S2;

E2<LDI≦E3 and LDISlope≧S1) defines the yellow zone.

Further, the lower part:

(E1<LDI≦E2 and LDISlope<S2; and

E2<LDI≦E3 and LDISlope<S1) defines as the Green Zone;

Thereafter, the ratio of Type I to Type II errors is optimized as desired, with priority typically given to Type I errors. The optimum solution provides LDI Slope as well as values for the threshold parameters E1, E2, E3, S1, and S2.

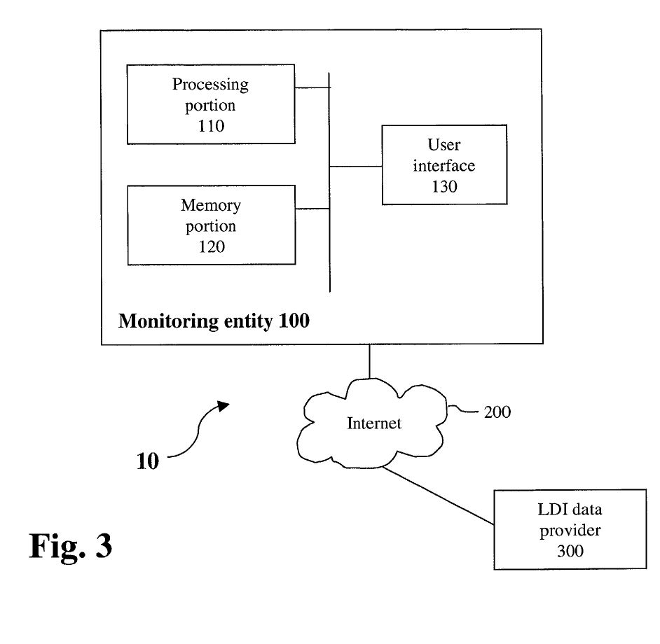

It should be appreciated that the process, in accordance with one embodiment of the invention as described above, may be practiced by a variety of systems. FIG. 3 is a block diagram illustrative of one monitoring system 10.

The monitoring system 10 includes a monitoring entity 100 and a LDI data provider 300. The monitoring entity 100 may be in communication with the LDI data provider 300 using any suitable arrangement and any suitable devices. As shown in FIG. 3, the monitoring entity 100 is in communication with the LDI data provider 300 through the Internet 200. However, any suitable network might be used. Further, it is not necessary that the LDI data be obtained off a network. For example, the LDI information might be provided on weekly CDs that are mailed, for example.

The monitoring entity 100 includes a processing portion 110, a memory portion 120 and a user interface portion 130. The processing portion 110 performs the data processing of the monitoring entity 100. Further, the memory portion 120 stores a variety of data used by the processing portion 110.

The monitoring entity 100 also includes the user interface portion 130. The user interface 130 allows the monitoring entity 100 to interface with a human user and/or another operating system. For example, the user interface portion 130 might be in the form of a keyboard, mouse and monitor, for example.

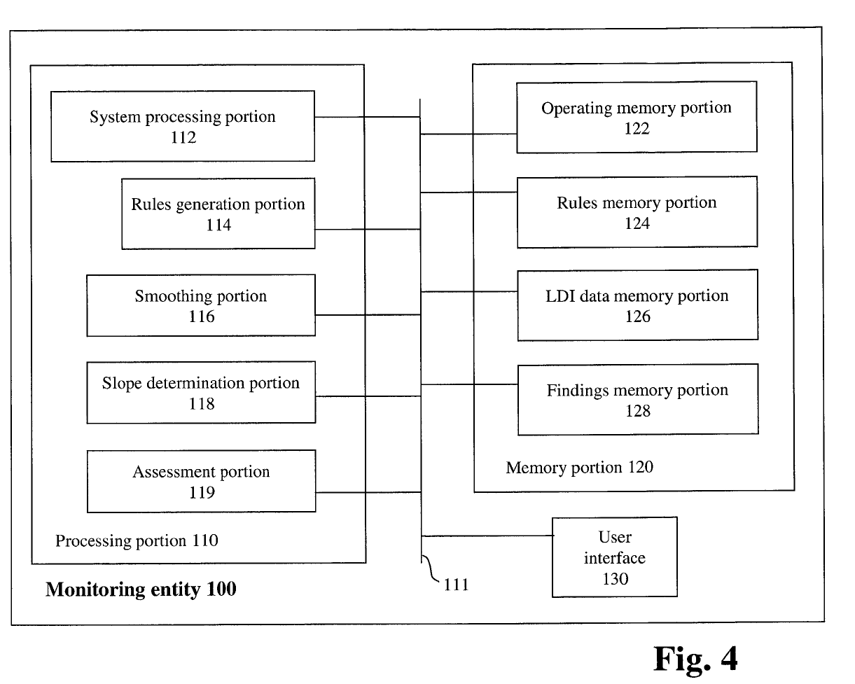

FIG. 4 is a block diagram showing the monitoring entity 100 in further detail. As shown, the processing portion 110 in the monitoring entity 100 includes a system processing portion 112. The system processing portion 112 handles a variety of operations in the processing portion 110, including general operations. These general operations might include controlling the input and output of data, control of overall processing and routine error recovery operations, for example.

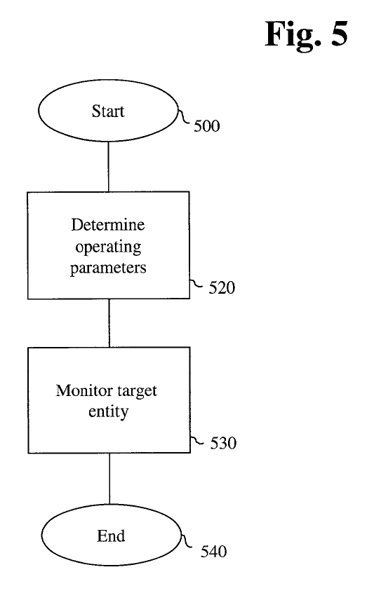

The processing portion 110 further includes a rules generation portion 114, a smoothing portion 116, a slope determination portion 118, and an assessment portion 119. The rules generation portion 114 generates the rules used in the monitoring entity 100 based on various criteria, as described herein. The smoothing portion 116 smoothes LDI values. Further, the slope determination portion 118 determines the slope of smoothed, i.e., adjusted, LDI values in accordance with one embodiment of the invention. The assessment portion 119 uses the present LDI value for an entity, and the LDI slope value, to map the financial disposition of a company, in accordance with one embodiment of the invention. The various components of the monitoring entity 100 may be in communication with each other via a suitable interface 111, as shown in FIG. 4. Further aspects of the components of the processing portion 110 are described below with reference to FIGS. 5-7.

The memory portion 120 as shown in FIG. 4 includes an operating memory portion 122. The operating memory portion 122 contains a variety of data used in the general operations of the monitoring entity 100. The memory portion 120 also contains a rules memory portion 124, a LDI data memory portion 126 and a findings memory portion 128.

The rules memory portion 124 contains data to formulate the rules used in the invention, as well as the actual rules themselves, including the threshold values, for example. The LDI data memory portion 126 contains the LDI data that is input from the LDI data provider 300, for example.

Also, the findings memory portion 128 in the memory portion 120 contains various information resulting from the processing of the monitoring entity 100, as determined by the assessment portion 119, for example. The information in the findings memory portion 128 might be conveyed to a human user through the user interface portion 130, or in some other suitable manner.

Further aspects of the monitoring entity 100 are hereinafter described below with reference to the flowcharts of FIGS. 5-7. FIG. 5 is a high level flowchart showing a process in accordance with one embodiment of the invention. As shown, the process of FIG. 5 starts in step 500 and then passes to step 520. In step 520, the process determines the operating parameters that are used in evaluating LDI values for a particular entity. It should be appreciated that the determination of the operating parameters need not be performed repeatedly for different entities. That is, step 520 might be performed only periodically throughout a year, for example, as desired so as to adjust the rules used in evaluating the LDI slope data. After step 520, the illustrative process of FIG. 5 passes to step 530.

In step 530, the process monitors a target entity. Further details of step 530, as well as step 520, are described below. After step 530, the process passes to step 540. In step 540, the process ends.

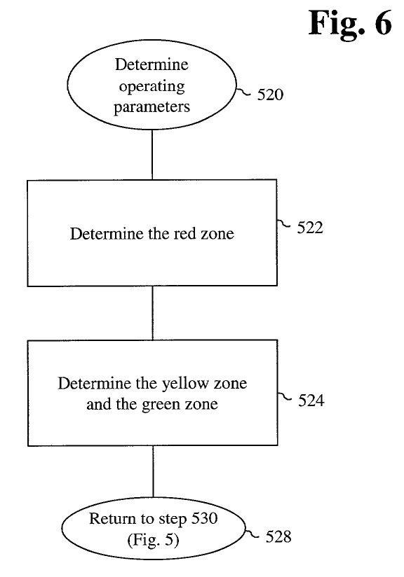

FIG. 6 is a flowchart showing in further detail the “determine operating parameters” step 520 of FIG. 5 in accordance with one embodiment of the invention. After the subprocess of FIG. 6 starts in step 520, the process passes to step 522. With reference to the illustrative system shown in FIG. 4, in step 522 the rules generation portion 114 determines the “Red Zone” in the manner described above. This may be performed by accessing a variety of historical data in the rules memory portion 124 and determining the thresholds based on optimization of the type I and the type II errors, as described above. After step 522, the process passes to step 524. In step 524, the rules generation portion 114 determines the yellow and the green zones. This may also be performed in the manner described above. After step 524, the process of FIG. 6 passes to step 528. In step 528, the process returns to step 530 of FIG. 4.

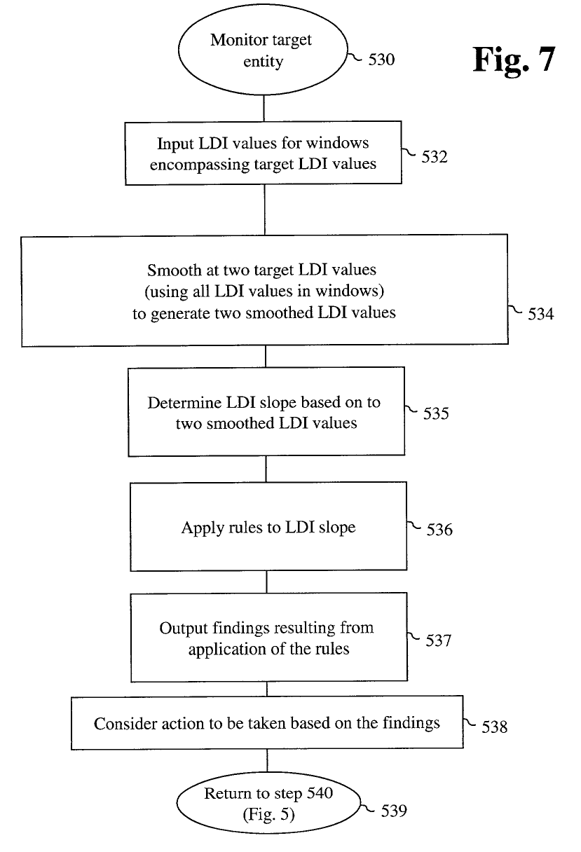

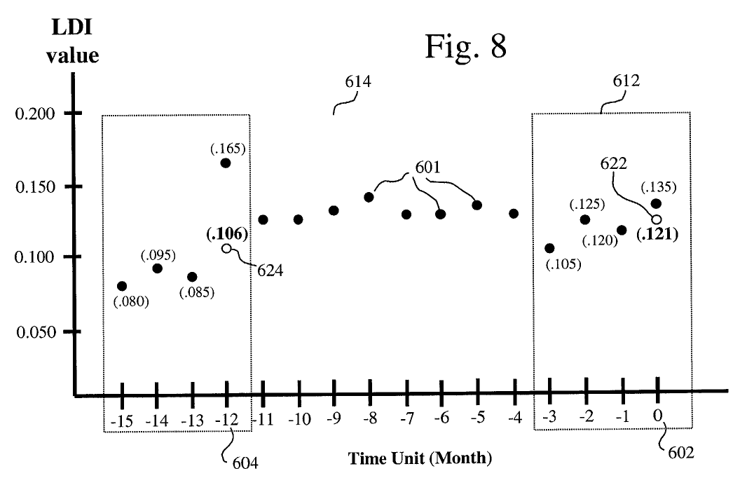

FIG. 7 is a flowchart showing in further detail the “monitor target entity” step 530 of FIG. 5 in accordance with one embodiment of the invention. The process of FIG. 7 starts in step 530 and then passes to step 532. With further reference to the illustrative operating system of FIG. 4, in step 532, the system processing portion 112 inputs LDI values for processing in accordance with one embodiment of the invention. Specifically, the system processing portion 112 inputs LDI data points, which are contained in windows encompassing target LDI values. FIG. 8 provides further illustration.

FIG. 8 is a diagram that shows LDI points or values 601 for each month. For example, FIG. 8 shows that the LDI value for the present month 602, i.e., month “0” as shown in FIG. 8, is 0.135. Further, the LDI value for 12 months ago, i.e., past month 604, is 0.165. In accordance with one embodiment of the invention, the LDI slope is determined by taking the present LDI value and an LDI value from 12 months ago—and processing such values using Equation 1, as described above. However, as should be appreciated a single LDI value may not be representative for one reason or another. As a result, the LDI values used in equation 1 above are smoothed. This smoothing may be performed using a window of values.

To explain, FIG. 8 shows LDI values for the present month “0”, as well as for the past 15 months. In accordance with one embodiment of the invention, a window 614 of four months is used to determine a past smoothed value 624. Further, a window 612 of four months is used to determine a present smoothed value 622, i.e., three months of data, in time proximity to the target month, as well as the target month value. Accordingly, the size of the windows to determine the past smoothed value 624 and the present smoothed value 622 may be varied as desired.

Returning to the flowchart of FIG. 7 and step 534, the smoothing portion 116 smoothes two target LDI values, using LDI values contained in the present window 612 and the past window 614. The target LDI values, in this example, include (a) the present LDI value at month 0, and (b) the LDI value 12 months ago. The present LDI value is 0.135. The LDI value at month 604, i.e., twelve months ago, is 0.165. As can be seen from FIG. 8, the 0.165 value appears to be an anomaly since the 0.165 value does not appear to follow with the trend of the other data points. However, the smoothing operation reduces the impact of the anomaly of this example.

This smoothing results in the generation of two smoothed LDI values, i.e., the present smoothed value 622 and the past smoothed value 624. In accordance with one embodiment of the invention, the smoothing process uses a simple average of all the LDI values in the respective windows, i.e., the target LDI value and the three previous LDI values. However, other methodologies could be used. For example, an LDI value immediately adjacent to the target LDI value might be weighed more heavily than an LDI value further away from the target LDI value. That is, if the target LDI value to be smoothed is 0.165 from twelve months ago, then the LDI value from month 13 might be more heavily weighted than the LDI value from month 15.

For example, a smoother may be used that depends on a parameter alpha (alpha a number between 0 and 1), called Exponentially Weighted Moving Average, EWMA (alpha), which weights the target LDI value by alpha and the LDI value at lag k (k=1, 2, . . . ) from the target LDI is weighted by: alpha*(1−alpha)\hat{ }k. For example, for an (alpha=0.1), the target LDI is weighted by 0.1; the previous (to target) LDI value is weighted by (0.1*0.9=0.09); and the LDI value 10 lags before the target value is weighted by 0.1*0.9\hat{ }10=0.035, for example.

Further, if a moving average filter is used for the smoothing, the number of points that the moving average filter uses may be varied, i.e., the number of points that are averaged. For example, if four points are used, then three data points adjacent the point to be smoothed are used. Thus, if the data point to be smoothed is September 2000, and a four point moving average filter is used, then September 2000, August 2000, July 2000 and June 2000 data points would be used. In the extreme, if one point is used in the moving average filter, then only the data point for September 2000 is used, for example, of course yielding the same value back since only one point is considered. That is, a “raw” LDI value may be used in the LDI slope determination, the raw LDI value not being smoothed.

Returning to FIG. 7, once the two smoothed LDI values are obtained, the process of FIG. 7 passes from step 534 to step 535. In step 535, the slope determination portion 118 in the processing portion 110 determines an LDI slope based on the smoothed values. In accordance with one embodiment of the invention, the slope determination portion 118 uses the relationship of Equation 1, described above:

LDI Slope_{—}t=100×(LDIt−LDIt−k)/LDIt−k

In accordance with the present example, the smoothed values 0.121 and 0.106 shown in FIG. 8 result in:

LDISlope_{—}t=100×(0.121−0.106)/0.106

LDISlope_{—}t=100×(0.141)

LDISlope_t=14.1 Equation 2

After step 535 of FIG. 7, the process passes to step 536. In step 536, the rules are applied using the LDI slope and the present LDI value, as is described in detail above. Specifically, the assessment portion 119, in the processing portion 110, for example, plots the entity in the risk space.

After step 536, the process passes to step 537. In step 537, the system processing portion 112 outputs the findings resulting from application of the rules. This finding may include an indication that the target entity being analyzed is in the Red Zone, the Yellow Zone, or the Green Zone. Then in step 538, action is considered based on the findings.

This action based on the findings may vary widely, as is discussed above. Illustratively, if the entity is plotted into the Green Zone, then “no action” might be the desired outcome. Alternatively, the present value (0.135) and the LDI slope may have resulted in a plot of the target entity in the yellow zone.

The Yellow Zone is suggestive that further action may be desired, as is described above. For example, the company might be included on a watch list. Alternately, the target company may have been plotted into the Red Zone. The Red Zone might be indicative that the market value of the company is significantly below cost basis. If a company is in the Red Zone, the company might be included on a watch list. Further, it may be deemed that no new unsecured investments will be permitted for a company plotted in the Red Zone, for example.

With further reference to FIG. 7, after step 538, the process passes to step 539. In step 539, the process returns to step 540, as shown in FIG. 5.

In further explanation of the determination of thresholds (E1, E2, E3, S1, S2): A company, or other entity, at any point in time, plots in the risk space defined by LDI and LDI slope, as a point. Companies (entities) that are financially healthy have a lower likelihood of default in the near future, therefore plot in a certain region of the risk space (Green Zone). Companies (entities) that are experiencing financial problems have higher likelihood of default and therefore they plot, in the risk space, in a different region (Yellow or Red Zone). Therefore, thresholds are defined that partition the risk space into categories which are associated with different levels of likelihood of default. A particular set of threshold values corresponds to a particular partition of the risk space into (default) risk categories and ultimately corresponds to a particular rule which can be used to predict default. The performance of such a rule is measured by looking at the balance between Type I and Type II errors, with higher emphasis on the value of the Type I error. Simulation and classification techniques may be used to obtain the rule that optimizes the balance between the two errors, with a certain constraint on the Type I error. This rule is defined by the thresholds E1, E2, E3, S1, S2 as described above in the present application.

It should further be appreciated that various portions or parts of the above described process might be performed by different parties or entities. For example, a user of the process described above might rely on a third party using an off-shore server to analyze the data and provide a recommendation. That is, for example, a user might not determine a LDI rate of change herself, but might instead obtain the LDI rate of change from another entity. The another entity would perform the processing to generate the LDI slope.

The systems and methods of the invention are subject to various embodiments and adaptations. As described above, FIGS. 3-4 show one embodiment of the system of the invention. Further, FIGS. 5-7 show various steps of a process in accordance with one embodiment of the invention. The system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks in accordance with the various embodiments of the invention. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example.

Further, it is not necessary that a single type of instruction or single programming language be utilized in conjunction with the operation of the systems and methods of the invention. Rather, any number of different programming languages may be utilized as is necessary or desirable. Also, the instructions and/or data used in the practice of the invention may utilize any compression or encryption technique or algorithm, as may be desired.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods of the invention, a variety of “user interfaces” may be utilized to allow a user to interface with the processing machine that is used to implement the invention. As used herein, a user interface includes any hardware, software, or combination of hardware and software used by the processing machine that allows a user to interact with the processing machine. A user interface may be in the form of a dialogue screen for example. A user interface, such as the user interface portion 130 described above, may also include any of a touch screen, keyboard, mouse, voice reader, voice recognizer, dialogue screen, menu box, a list, a checkbox, a toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the systems and methods of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the systems and methods of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

What is claimed is:

1. A method for processing data to determine the likelihood of default of an entity, the method comprising:
obtaining a data set relating to an entity, the data set including at least a first likelihood of default indicator (LDI) value and a second LDI value;
determining a LDI rate of change, based on the first LDI value and the second LDI value, to provide a LDI slope value; and
determining the likelihood of default of the entity based on the LDI slope value and the first LDI value.

2. The method of claim 1, wherein the first LDI value is a present value and the second LDI value is a past value.

3. The method of claim 1, wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value; and
wherein the determining the LDI rate of change is performed based on the past window of past LDI values and the present window of present LDI values.

4. The method of claim 3, wherein the determining the LDI rate of change based on the past window of LDI values and the present window of LDI values includes smoothing the second LDI value and smoothing the first LDI value.

5. The method of claim 4, wherein:
smoothing the second LDI value results in the generation of a past smoothed value; and
smoothing the first LDI value results in the generation of a present smoothed value; and
wherein the past smoothed value is processed with the present smoothed value to provide the LDI slope value.

6. The method of claim 5, wherein the determining a LDI rate of change includes comparing the past smoothed value with the present smoothed value.

7. The method of claim 6, wherein comparing the past smoothed value with the present smoothed value to determine the LDI rate of change includes using a relationship:
LDI rate of change=100×(present smoothed value−past smoothed value)/past smoothed value.

8. The method of claim 1, wherein the first LDI value is a present LDI value.

9. The method of claim 8, wherein the LDI slope value and the first LDI value are plotted in a two-dimensional risk space.

10. The method of claim 9, wherein the risk space is divided into zones based on LDI threshold values and LDI slope value thresholds.

11. The method of claim 1, further including generating a two-dimensional risk space by plotting LDI values on a first axis and plotting LDI slope values on a second axis; and
plotting the LDI slope value and the first LDI value, which is a present LDI value, into the two-dimensional risk space.

12. The method of claim 11, further including determining threshold values, which separate the risk space into zones, based on an optimization of type I and type II errors; wherein:
a type I error is an error in which a default signal was not given and a test entity defaulted; and
a type II error is an error in which a default signal was given and a further test entity did not default.

13. The method of claim 1, wherein the determining a LDI rate of change, based on the first LDI value and the second LDI value, to provide a LDI slope value includes:
comparing the first LDI value and the second LDI value.

14. The method of claim 1, wherein the determining a LDI rate of change, based on the first LDI value and the second LDI value, to provide a LDI slope value includes:
smoothing the first LDI value along with other LDI values proximate to the first LDI value to generate a present smoothed LDI value;
smoothing the second LDI value along with other LDI values proximate to the second LDI value to generate a past smoothed LDI value; and
comparing the present smoothed LDI value and the past smoothed LDI value.

15. The method of claim 14, wherein the smoothing includes using an average calculation.

16. A computer readable memory for directing the operation of a processing system to determine the likelihood of default of an entity, the computer readable memory comprising:
a first portion that stores a data set relating to an entity, the data set including at least a first likelihood of default indicator (LDI) value and a second LDI value;
a second portion to determine a LDI rate of change, based on the first LDI value and the second LDI value, to provide a LDI slope value; and
a third portion to determine the likelihood of default of the entity based on the LDI slope value and the first LDI value, the first LDI value being a present value.

17. The computer readable memory of claim 16, wherein the first LDI value is a present day value and the second LDI value is a past day value; and
wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value; and
wherein the second portion determines the LDI rate of change based on the past window of past LDI values and the present window of present LDI values.

18. The computer readable memory of claim 17, wherein the second portion determines the LDI rate of change based on the past window of LDI values and the present window of LDI values by smoothing the second LDI value and smoothing the first LDI value; and wherein:
smoothing the second LDI value results in the generation of a past smoothed value; and
smoothing the first LDI value results in the generation of a present smoothed value; and
wherein the second portion compares the past smoothed value with the present smoothed value to provide the LDI slope value.

19. A system for determining the likelihood of default of an entity, the system comprising:
a memory portion that stores a data set relating to an entity, the data set including at least a first likelihood of default indicator (LDI) value and a second LDI value;
a slope determination portion that determines a LDI rate of change, based on the first LDI value and the second LDI value, to provide a LDI slope value; and
an assessment portion to determine the likelihood of default of the entity based on the LDI slope value and the first LDI value.

20. The system of claim 19, wherein the assessment portion plots the LDI slope value and the first LDI value onto a two-dimensional risk space, the risk space defined by a plurality of LDI slope values and a plurality of LDI values.

21. The system of claim 19, wherein the first LDI value is a present day value and the second LDI value is a past day value; and
wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value; and
wherein the slope determination portion determines the LDI rate of change based on the past window of past LDI values and the present window of present LDI values.

22. The system of claim 21, wherein the slope determination portion determining the LDI rate of change based on the past window of LDI values and the present window of LDI values includes smoothing the second LDI value and smoothing the first LDI value; and wherein:
smoothing the second LDI value results in the generation of a past smoothed value; and
smoothing the first LDI value results in the generation of a present smoothed value; and
wherein the slope determination portion compares the past smoothed value with the present smoothed value to provide the LDI slope value; and
wherein comparing the past smoothed value with the present smoothed value to determine the LDI rate of change includes using the relationship:
LDI rate of change=100×(present smoothed value−past smoothed value)/past smoothed value.

23. A method for processing data to determine the likelihood of default of an entity, the method comprising:
obtaining a data set relating to an entity, the data set including at least a first likelihood of default indicator (LDI) value and a second LDI value;
inputting an LDI slope value, the LDI slope value having been determined from a LDI rate of change based on the first LDI value and the second LDI value; and
determining the likelihood of default of the entity based on the LDI slope value and the first LDI value.

24. The method of claim 23, wherein the LDI slope value having been determined from a LDI rate of change based on the first LDI value and the second LDI value includes:
smoothing the first LDI value along with other LDI values proximate to the first LDI value to generate a present smoothed LDI value;
smoothing the second LDI value along with other LDI values proximate to the second LDI value to generate a past smoothed LDI value; and
comparing the present smoothed LDI value and the past smoothed LDI value.

25. The method of claim 23, wherein:
the LDI slope value having been determined from a LDI rate of change based on the first LDI value and the second LDI value is performed by a first entity; and
determining the likelihood of default of the entity based on the LDI slope value and the first LDI value is performed by a second entity.

26. A method for processing data to determine the likelihood of default of an entity, the method comprising:
obtaining a data set relating to an entity, the data set including at least a first likelihood of default indicator (LDI) value and a second LDI value, the first LDI value is a present day value and the second LDI value is a past day value;
determining a LDI rate of change, based on the first LDI value and the second LDI value, to provide a LDI slope value; and
determining the likelihood of default of the entity based on the LDI slope value and the first LDI value; and
wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value; and
wherein the determining the LDI rate of change is performed based on the past window of past LDI values and the present window of present LDI values, the determining the LDI rate of change based on the past window of LDI values and the present window of LDI values includes smoothing the second LDI value and smoothing the first LDI value to respectively generate a past smoothed value and a present smoothed value; and
wherein the past smoothed value is compared with the present smoothed value to provide the LDI slope value.

27. The method of claim 26, further including plotting the LDI slope value and the first LDI value onto a two-dimensional risk space, which is divided into zones based on LDI threshold values and LDI slope value thresholds.

28. A computer readable memory for directing the operation of a processing system to determine the likelihood of default of an entity, the computer readable memory comprising:
a first portion that stores a data set relating to an entity, the data set including at least a first likelihood of default indicator (LDI) value and a second LDI value, the first LDI value being a present day value and the second LDI value being a past day value;
a second portion to determine a LDI rate of change, based on the first LDI value and the second LDI value, to provide a LDI slope value; and
a third portion to determine the likelihood of default of the entity based on the LDI slope value and the first LDI value, the first LDI value being a present value; and
wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value, the second portion determining the LDI rate of change based on the past window of past LDI values and the present window of present LDI values by smoothing the second LDI value and smoothing the first LDI value; and
smoothing the second LDI value results in the generation of a past smoothed value; and
smoothing the first LDI value results in the generation of a present smoothed value; and
wherein the second portion compares the past smoothed value with the present smoothed value to provide the LDI slope value.

29. A system for determining the likelihood of default of an entity, the system comprising:
a memory portion that stores a data set relating to an entity, the data set including at least a first likelihood of default indicator (LDI) value and a second LDI value, the first LDI value is a present day value and the second LDI value is a past day value;
a slope determination portion that determines a LDI rate of change, based on the first LDI value and the second LDI value, to provide a LDI slope value; and
an assessment portion to determine the likelihood of default of the entity based on the LDI slope value and the first LDI value; and
wherein the data set further includes a past window of LDI values and a present window of LDI values;
the past window of LDI values containing a plurality of past LDI values disposed in time proximity to the second LDI value; and
the present window of LDI values containing a plurality of present LDI values disposed in time proximity to the first LDI value; and
wherein the slope determination portion determines the LDI rate of change based on the past window of past LDI values and the present window of present LDI values, the slope determination portion determining the LDI rate of change based on the past window of LDI values and the present window of LDI values includes smoothing the second LDI value and smoothing the first LDI value; and wherein:
smoothing the second LDI value results in the generation of a past smoothed value; and
smoothing the first LDI value results in the generation of a present smoothed value; and
wherein the slope determination portion compares the past smoothed value with the present smoothed value to provide the LDI slope value, the comparing the past smoothed value with the present smoothed value to determine the LDI rate of change includes using a relationship:
LDI rate of change=100×(present smoothed value−past smoothed value)/past smoothed value.
